(19) United States
(12) Patent Application Publication
(10) Pub. No.: US 2006/0163148 A1
(43) Pub. Date: Jul. 27, 2006

(54) Filter housing for a drinking water pitcher

(76) Inventors: Steve L. Hengsperger, Windsor (CA); Justin L. Namespetra, Essex (CA); Christopher B. Caldwell, Stoney Creek (CA); Richard S. Zulik, Beamsville (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/335,502

(22) Filed: Jan. 20, 2006

Related U.S. Application Data
(60) Provisional application No. 60/645,073, filed on Jan. 21, 2005.

(51) Int. Cl. B01D 24/00

(52) U.S. Cl. 210/473

(57) ABSTRACT

A filter housing for a drinking water pitcher is provided. The filter housing includes an upper housing portion and a lower housing portion. A filter media can be housed in between the upper and lower housing portions. The upper and lower housing portions co-operate to provide increased water flow through rate. The filter housing includes a necked down inlet port. Chambers in the upper housing are filled with air. Preferably, an angle of the lower housing preferably extends to the exit port to create a consistent surface tension across the entire surface of the filter media. The filter housing is preferably placed between an upper reservoir and a lower reservoir of the drinking water pitcher, and can be removably attached to, or seated within, the lower reservoir.

### CROSS-REFERENCE TO RELATED APPLICATIONS

This application claims the benefit of priority of U.S. Provisional Patent Application Ser. No. 60/645,073, filed Jan. 21, 2005, which is incorporated herein by reference.

### FIELD OF THE INVENTION

The present invention relates generally to drinking water pitchers. More particularly, the present invention relates to a filter housing for a drinking water pitcher.

### BACKGROUND OF THE INVENTION

Increased concern from the public on issues of water quality has resulted in an explosion of water filtration devices on the market, particularly for household use. A popular household water filtration device is in the style of a pour-through pitcher. Typically, unfiltered water is added to a basin at the top of the device. Through the action of gravity, water percolates through a filtering media (usually consisting of granulated activated carbon) located between the basin and a collection reservoir. Filtered water is then dispensed from the collection reservoir for drinking. For the general public, gravity-controlled pitcher-type water filtration systems are cost effective. Many such water filtration systems are provided under the Brita® and PUR® brand names.

There are many types of gravity flow water filters that focus primarily on the removal of harmful contaminants in drinking water such as chlorine and sediment. These tend to consist of an upper reservoir with a removable filter cartridge installed in it. All the water flows through the filter and is deposited in the lower reservoir. This type of filtration method is common in the art.

One of the major complaints from consumers relating to known conventional filter housing and filter media arrangements is that it takes too long for the water to be filtered, such as through the granulated activated carbon (GAC) filters found in a Brita drinking water pitcher. These previous approaches have somewhat of an inherent requirement to have the water flow through the filter media slowly, since granulated activated carbon filters and other filters work on the principle of contact time of the water with the carbon granules. Nevertheless, the relatively long time it takes for water to be filtered in these pitchers is a deterrent to purchase of such products, as well as to continued use of the products.

Moreover, when the GAC has passed the time when it is most effective, the entire GAC filter cartridge must be replaced. There is no way to only replace the active portion of the sealed cartridge, possibly due to potential hazards in GAC handling.

Some known approaches include a filter media that is removable from a filter housing. The filter housing can include some features to assist in facilitating or increasing the flow of water through the filter media.

It is, therefore, desirable to provide a filter housing for a drinking water pitcher that overcomes at least one drawback of previous filter housings.

### SUMMARY OF THE INVENTION

It is an object of the present invention to obviate or mitigate at least one disadvantage of previous filter housings for drinking water pitchers.

In an aspect, the present invention provides a filter housing for a drinking water pitcher, including an upper housing portion. The upper housing portion includes a necked down inlet port in an upper surface thereof to increase water flow through rate. The upper housing portion also includes an upper housing chamber to trap air to provide substantially uniform pressure across a lower opening of the upper housing portion. The filter housing further includes a lower housing portion defining an exit port in a lower surface thereof, a volume of the lower housing portion increasing in proximity to the exit port to prevent bottleneck.

The volume of the lower housing portion can increase progressively in proximity to the exit port. The volume of the lower housing portion can have a greater depth at the middle of the lower surface than at the outer portions of the lower surface. The lower surface of the lower housing portion can extend to the exit port at an angle. The angle of the lower surface can be about 6.2 degrees from the horizontal.

The lower housing portion can define a single exit port to provide a single stream of water flowing out from the filter housing. The exit port can be provided at about the center of the lower housing portion.

The lower housing portion can have a greater depth at the outer portions of the lower surface than at the middle of the lower surface. The exit port can include an exit ring adjacent the outer perimeter of the lower surface. The lower surface of the lower housing portion can be a disk shaped area. The lower surface of the lower housing portion can further include ribs to direct water flow towards the exit port. The necked down inlet port can have a smaller cross-sectional area at the bottom thereof than at the top thereof.

The upper housing portion and the lower housing portion can each comprise locking portions co-operating with each other to removably secure the upper housing portion to the lower housing portion. The upper housing portion and/or the lower housing portion can include a gripping means.

The upper housing portion and the lower housing portion can be shaped and constructed to hold a flat carbon fabric filter in the range of about 2 inches to about 4 inches, preferably between about 2.25 inches and about 3.62 inches and most preferably about 3 inches in diameter.

The filter housing can further include a filter media holder for securing a filter media in between the upper and lower housing portions. The filter housing can further include a filter media housed in between the upper and lower housing portions. The filter media can be a flat carbon fabric filter.

In another aspect, the present invention provides a filter for a drinking water pitcher, the filter including an upper housing portion, a lower housing portion, and a filter media housed in between the upper and lower housing portions. The upper housing portion includes a necked down inlet port in an upper surface thereof to increase water flow through rate, and an upper housing chamber to trap air to provide substantially uniform pressure across the filter media. The lower housing portion defines an exit port in a lower surface thereof. The volume of the lower housing portion increases in proximity to the exit port to create a substantially consistent surface tension across the filter media, and preferably to prevent bottleneck.

The filter can further include a filter media holder for securing the filter media in between the upper and lower housing portions. The filter media can be a flat carbon fabric filter.

In a further aspect, the present invention provides a filter for a drinking water pitcher, including an upper housing portion. The upper housing portion includes a necked down inlet port in an upper surface thereof to increase water flow through rate. The upper housing portion also includes an upper housing chamber to trap air to provide substantially uniform pressure across a lower opening of the upper housing portion. The filter further includes a lower housing portion including a granulated activated carbon (GAC) filter. The lower housing portion can define an exit port in a lower surface thereof, and a volume of the lower housing portion can increase in proximity to the exit port to prevent bottleneck.

In a yet further aspect, the present invention provides a drinking water pitcher, including an upper reservoir, a lower reservoir, and a filter provided between the upper reservoir and the lower reservoir such that head pressure from the upper reservoir is applied within the filter. The filter includes an upper housing portion, a lower housing portion, and a removable filter media housed in between the upper and lower housing portions. The upper housing portion includes a necked down inlet port in an upper surface thereof to increase water flow through rate, and an upper housing chamber to trap air to provide substantially uniform pressure across the filter media. The lower housing portion defines an exit port in a lower surface thereof. The volume of the lower housing portion increases in proximity to the exit port to create a substantially consistent surface tension across the filter media.

The filter housing can be removably attached to the lower reservoir, or can be seated within the lower reservoir. The filter housing can be removably attached to the upper reservoir, or integral with the upper reservoir. The upper housing portion and a bottom surface of the upper reservoir can be complementary in shape.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a close up section view showing geometric features of a filter housing according to an embodiment of the present invention;

FIG. 2A is a top isometric view of a top portion of a filter housing according to an embodiment of the present invention;

FIG. 2B is a bottom isometric view of a bottom portion of a filter housing according to an embodiment of the present invention;

FIG. 3 illustrates an exploded view of a filter housing according to an embodiment of the present invention;

FIG. 4A is a top isometric view of a top portion of a filter housing according to another embodiment of the present invention;

FIG. 4B is a bottom isometric view of a bottom portion of a filter housing according to another embodiment of the present invention;

FIG. 5 illustrates an exploded view of a filter housing according to another embodiment of the present invention;

FIG. 6 is a section view of a drinking water pitcher including a filter housing according to an embodiment of the present invention;

FIG. 7 is a close up section view of the filter housing and surrounding elements of FIG. 6;

FIG. 8 illustrates a side sectional view of a drinking water pitcher including a filter housing according to a further embodiment of the present invention; and

FIG. 9 is a close up section view of the filter housing and surrounding elements of FIG. 8.

### DETAILED DESCRIPTION

Generally, the present invention provides a filter housing for a drinking water pitcher. The filter housing includes an upper housing portion and a lower housing portion. A filter media can be housed in between the upper and lower housing portions. The upper and lower housing portions co-operate to provide increased water flow through rate. The filter housing includes a necked down inlet port. Chambers in the upper housing are filled with air. An angle of the lower housing preferably extends to the exit port to create a consistent surface tension across the entire surface of the filter media. The filter housing is preferably placed between an upper reservoir and a lower reservoir of the drinking water pitcher, and can be removably attached to, or seated within, the lower reservoir.

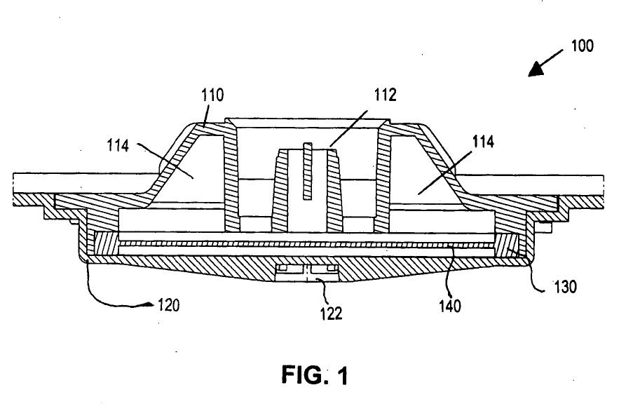

FIG. 1 is a close up section view showing geometric features of a filter housing according to an embodiment of the present invention. The filter housing shown in FIG. 1 includes a filter, though it is to be understood that the filter housing can be provided without a removable filter, which can be separately purchased by a consumer. As such, FIG. 1 illustrates a filter 100 for a drinking water pitcher. The filter includes a filter housing, which itself includes an upper housing portion 110 and a lower housing portion 120. The filter also includes a filter media 130 housed in between the upper and lower housing portions. The upper housing portion 110 includes a necked down inlet port 112 in an upper surface thereof to increase water flow through rate. The upper housing portion also includes an upper housing chamber 114 to trap air to provide substantially uniform pressure across the filter media. The embodiment shown in FIG. 1 illustrates two upper housing chambers 114.

The lower housing portion 120 defines an exit port 122 in a lower surface thereof. The volume of the lower housing portion increases in proximity to the exit port to create a substantially consistent surface tension across the filter media, and preferably to prevent bottleneck. The term “bottleneck” as used herein represents a bottleneck of water flow out of the lower housing portion of the filter housing.

The filter 100 can further include a filter media holder 140 for securing the filter media 130 in between the upper and lower housing portions. The filter media 130 can be a flat carbon fabric filter. Further details regarding the filter media will be described later.

With respect to the geometry of the filter housing, there are three features illustrated in FIG. 1 that contribute to the faster water pour through rates using a filter housing according to an embodiment of the present invention. They will now be described in further detail.

Feature 1: The upper portion of the filter housing has a necked down inlet port 112. This can generally be further described as the inlet port having a smaller surface area, or diameter, at the bottom thereof than at the top thereof. This decreases the surface area of the port and means that as the water enters the filter housing it will be travelling at an increased rate. This means that as the water hits the thin filter media, it can travel through the media at an increased rate. Although a particular arrangement is shown with respect to angles of neck down and the degree to which the surface area of the port is decreased, it is possible to vary the upper and lower diameters of these ports and obtain a variation in water pour through rates.

Feature 2: Before the upper reservoir is assembled to the filter housing, one or more chambers 114 in the upper level of the filter housing are preferably filled with air. When the upper reservoir is attached and the water begins to flow, the air has nowhere to go and is therefore pressurized in this chamber due to the head pressure created by the weight of the water. This ensures substantially consistent, or even, pressure across substantially the entire surface of the filter media. This pressure, or force, across the entire surface of the filter media works to enhance the rate of flow of water through the media. Also, in known filters the water flow tends to create a channel over time (path of least resistance). The even pressure on the filter media because of the air filled chamber works to offset this effect and thus enhances the life of the filter.

With respect to feature 2, the air exerts pressure on the water due to the fact that air is lighter than water. Although a particular size and shape of chamber 114 is shown to be filled-with air, the size, shape and volume of this chamber can be varied, and only a presently preferred embodiment is shown in the drawings. According to embodiments of the present invention the air filled chamber encourages, and preferably produces, a substantially constant and/or uniform water flow across the water filter, and reduces the occurrence of focal points of water flow in the filter. This phenomenon can be described as acting as a spring or as a pressure stabilizer in this system. Every part of the filter preferably has water flowing through it as opposed to granulated activated carbon filters where tunnelling often occurs.

Feature 3: In general, a volume of the lower housing portion 120 increases in proximity to the exit port 122 to prevent bottleneck. This can be achieved in any number of ways, such as by a curved surface, or a series of graduated surfaces arranged in a stair or step-like arrangement. The volume of the lower housing portion can increase progressively in proximity to the exit port. The volume of the lower housing portion can have a greater depth at the middle of the lower surface than at the outer portions of the lower surface. Finally, the lower surface of the lower housing portion can extend to the exit port at an angle. The angle of the lower housing portion of the filter housing preferably extends towards the exit port to help keep a smooth flow of water between the underside of the filter media and the exit port of the filter housing.

Whether or not an angle is used to have a volume of the lower housing portion increasing in proximity to the exit port, this feature of increasing volume ensures that the surface tension on the underside of the filter media is substantially consistent across substantially its entire surface. The water hangs due to surface tension from the surface briefly as it passes through the filter. This “hanging” of the water creates a suction effect due to the water's small weight. This suction pulls water through the filter at an increased rate. The angle of the lower portion can alternatively be expressed as the ratio between the height of the lower portion and the distance between the beginning of the sloping portion near the edge of the housing bottom and the end of the sloped or tapered portion which terminates at the exit port This ratio is also related to the overall diameter of the filter media. Considering that water has a meniscus or surface tension, as water fills up the chamber of the lower portion of the filter housing, it flows out in such a way that the weight of the water in the lower portion of the housing is pulling on the underside creating a negative pressure zone. This acts as a suction on the other side, thereby increasing the flow rate.

Although a particular angle and ratio relationship is shown in the drawings, the general approach is one in which a lower portion of the housing has a greater depth at the middle of the lower portion than at the outer portion. This takes into account the fact that as water hits the bottom portion of the filter housing on the outside, and travels towards the exit port in the middle, it accumulates. Therefore, having a tapered lower portion prevents the accumulation from slowing the flow and, in fact, assists in encouraging the flow. This arrangement preferably provides a substantially constant volume to flow rate relationship across substantially the entire lower portion of the housing.

In an exemplary embodiment, the angle of the lower filter housing portion is about 6.2°, which can alternatively be expressed as a height change of about 3.315 mm over a radius change of about 30.15 mm. The ratio of the lower filter housing measurements can be designed for better performance in a particular range of flow rates, or at a particular flow rate. If the geometry of the upper filter housing is varied in order to create a different flow rate, the lower filter housing should preferably be modified such that the angle of tapering cooperates best with the anticipated water flow rate.

As shown in the figures, in an embodiment the lower housing portion 120 can define a single exit port 122 to provide a single stream of water flowing out from the filter housing. The exit port can be provided at about the center of the lower housing portion.

In an alternative embodiment (not illustrated), the lower housing portion 120 can have a greater depth at the outer portions of the lower surface than at the middle of the lower surface. In that case, the exit port 120 can include an exit ring adjacent the outer perimeter of the lower surface. The lower surface of the lower housing portion can be a disk shaped area, in which case an exit ring can be provided adjacent the outer circumference. The angle of the base of the lower filter housing in that case is the reverse of that shown in the figures, namely increasing the volume under the filter media as the water approaches the ring on the outer edge of the lower filter housing (or when observed from the middle to the outer edge). In other words, the shape is substantially similar to a reverse cone from the illustrations.

In further alternative embodiments the exit ring can be located at any point on the bottom wall of the lower filter housing piece, as long as the angle in question increases the volume progressively as the water approaches the exit port once it has passed through the filter media.

Therefore, certain embodiments of the present invention can broadly be described as providing a filter housing including a lower housing portion, the lower housing portion having an exit port, the lower housing portion being angled such that the volume of the lower housing portion increases, preferably progressively, in proximity to the exit port. The exit port can be a single port, a plurality of ports, an exit ring, an exit port adjacent the circumference of a lower surface of the lower housing portion, or any other suitable implementation.

Although the three features discussed above are found in combination in the presently preferred embodiment shown in the drawings, such as in FIG. 1, it may be possible to provide only one or two of these features and still achieve an improved water flow rate over previous filters using the filter housing according to embodiments of the present invention. Various combinations of the features are possible according to embodiments of the present invention.

While one or two of these features can be found together in some known approaches, the purpose in those known approaches is typically very different. For example, there is a known system in which the whole filter housing is filled with carbon material. That known filter housing includes a necked down inlet port, and includes channels and walls, but the purpose of each of these features is to direct water along a sinuous path to increase contact time. Increasing contact time is a goal that stands in contrast with one of the aims of embodiments of the present invention, which is to increase water flow through rate.

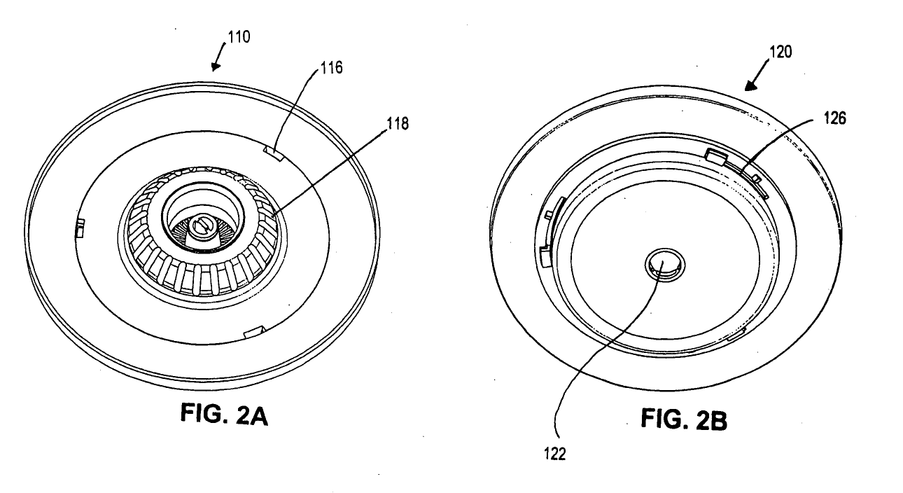

Although embodiments shown in FIG. 1 illustrates a filter housing including a filter media, embodiments of the present invention also preferably provide a filter housing for use with a filter, i.e. the filter media need not be included as part of the filter housing. FIG. 2A is a top isometric view of a top portion, or upper housing portion, 110 of a filter housing according to an embodiment of the present invention. FIG. 2B is a bottom isometric view of a bottom portion, or lower housing portion, 120 of a filter housing according to an embodiment of the present invention;

The filter housing according to the embodiment in FIGS. 2A and 2B can be disassembled and a portion removed in order to replace only the filter media without having to replace or discard the entire filter housing. This is in contrast to presently known water filter systems, particularly household or consumer systems. In known systems, the filter media is integrated within, and is not removable from, the filter housing or casing, sometimes referred to as a cartridge. This obviously results in advantages of decreased replacement costs since only the filter media needs to be replaced, as well as better environmental stewardship, since the filter housing itself can be reused.

Embodiments of the present invention also advantageously provide a filter housing that is designed to be openable, in order to replace the filter housed therein. In some embodiments, the top of the filter housing is the part that can be detached, where as in others it is the bottom that can be detached. In either case, the filter housing is designed to be re-usable.

FIG. 2A shows an upper filter housing that can be lockably engaged with a lower filter housing shown in FIG. 2B. The upper housing portion and the lower housing portion can each comprise locking portions co-operating with each other to removably secure the upper housing portion to the lower housing portion. Upper housing locking portions 116 are shown in FIG. 2A, and lower housing locking portions 126 are shown in FIG. 2B. The upper housing portion and/or the-lower housing portion can include a gripping means.

The upper housing 110 of FIG. 2A includes grip elements 118 to facilitate twisting and removal of the upper filter housing to access the filter media for replacement. The geometry of the upper housing 110 preferably mates and seals with an upper reservoir of a drinking water pitcher. In the embodiment shown in FIG. 2B, the water exit port 122 is shown clearly in the center of the bottom filter housing. The filter media can include a fabric such as a carbon fabric filter. A plastic disk can optionally be provided, on which the fabric is placed in order to properly insert it into the filter housing.

One advantage afforded by this arrangement is that instead of buying a package of replacement filter cartridges, it would be possible to buy a package of filter fabric disks, thereby saving costs in materials, packaging, etc. This provides reduced costs to the consumer. Initial estimates are that one would be able to purchase 10 replacement filter fibre disks for a similar cost as is presently incurred in purchasing 3 replacement granulated activated carbon cartridges.

As such, an embodiment of the invention in which a filter housing is provided without a filter media can be described as follows. In an aspect, the present invention provides a filter housing for a drinking water pitcher, including an upper housing portion. The upper housing portion includes a necked down inlet port in an upper surface thereof to increase water flow through rate. The upper housing portion also includes an upper housing chamber to trap air to provide substantially uniform pressure across a lower opening of the upper housing portion. The filter housing further includes a lower housing portion defining an exit port in a lower surface thereof, a volume of the lower housing portion increasing in proximity to the exit port to prevent bottleneck.

In embodiments where the filter housing is provided without the filter media, characteristics of the upper housing portion are described in relation to the pressure or force exerted on a lower opening of the upper housing portion, rather than in relation to the filter media.

Of course, the filter housing can further include a filter media holder for securing a filter media in between the upper and lower housing portions. The filter housing can further include a filter media housed in between the upper and lower housing portions. The filter media can be a flat carbon fabric filter.

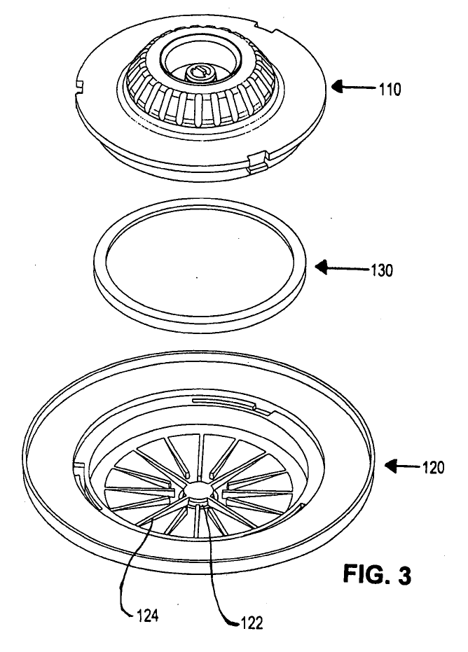

FIG. 3 illustrates an exploded view of a filter housing according to an embodiment of the present invention. As shown in FIG. 3, the lower surface of the lower housing portion 120 can further include ribs 124 to direct water flow towards the exit port 122. The ribs 124 are preferably provided on the inside of the lower housing portion to encourage and/or directing the flow of water out towards the exit port. In terms of the filter media 130 used in the filter housing, one or more filter layers can be used. Using more filters, or filter layers, can result in increased filter efficiency, though this may reduce the water flow rate.

The use of a flat carbon fabric filter as the filter media 130 provides some advantages over the use of known GAC filter cartridges. For example, a GAC filter typically slows down in performance over time as sediment builds up within the filter. In contrast, tests have shown that the carbon fabric filter can actually increase in efficiency over time. Also shown in the tests, regardless of the diameter of the carbon material filter used, the performance was consistently better, i.e. faster, than traditional drinking water pitchers such as Brita® pitchers including a GAC filter.

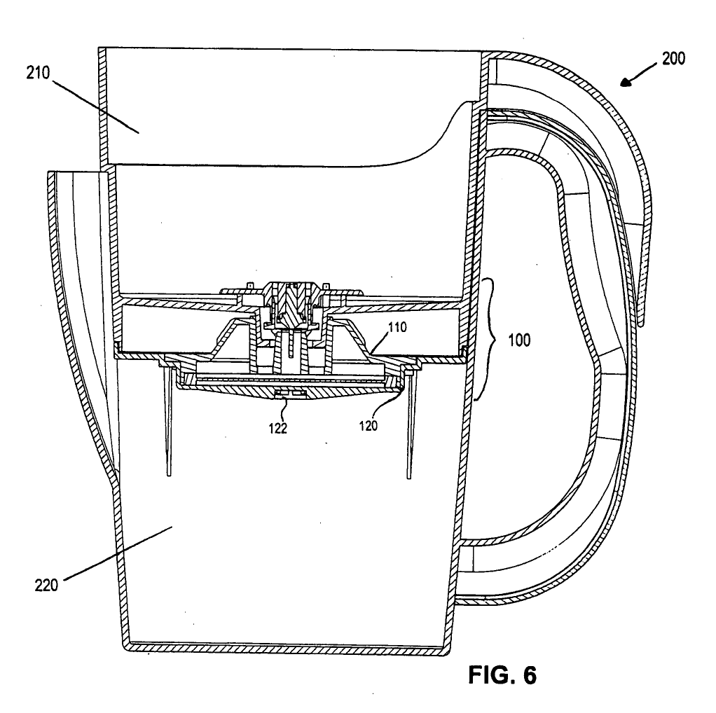

Another advantage of the fabric disk water filter over GAC filters is that over time GAC filters retain moisture. That retained moisture encourages the growth of bacteria. Consequently, water passing through a GAC filter could potentially include bacteria growing in the filter itself, as a result of contact time with the bacteria in the filter. This is despite the filtration for other elements, such as chlorine. When using a filter housing in accordance with the embodiment of the present invention, this can be overcome by using a pitcher such as shown in FIG. 6 (described later) in conjunction with a base unit. The upper reservoir in that case is removably mountable to a base unit that provides ozonation to tap water. Then ozonated water can then pass through the fabric filter, thereby avoiding problems associated with bacteria growth, since the bacteria is killed during the ozonation process. Carbon filters themselves do not kill bacteria organisms, such as e. coli.

Such a base unit is described in co-pending U.S. Provisional Patent Application Serial No. 60/645,072, filed Jan. 21, 2005 and entitled “Drinking Water Pitcher Having Removable Upper Reservoir”, which is incorporated herein by reference. Further discussion of the base unit, of sanitization system, can be found in any one of applicant's published international (PCT) applications WO 2004/063098, WO 2004/063100, and WO 2004/113232, each of which is incorporated herein by reference.

Once again, the filter housing and filter media shown in FIG. 3 illustrates that the filter housing can be easily opened to access the filter media 130. This allows a consumer to remove and replace only the filter media, and not the entire filter housing itself. This means that the cost for replacing the filter is greatly reduced.

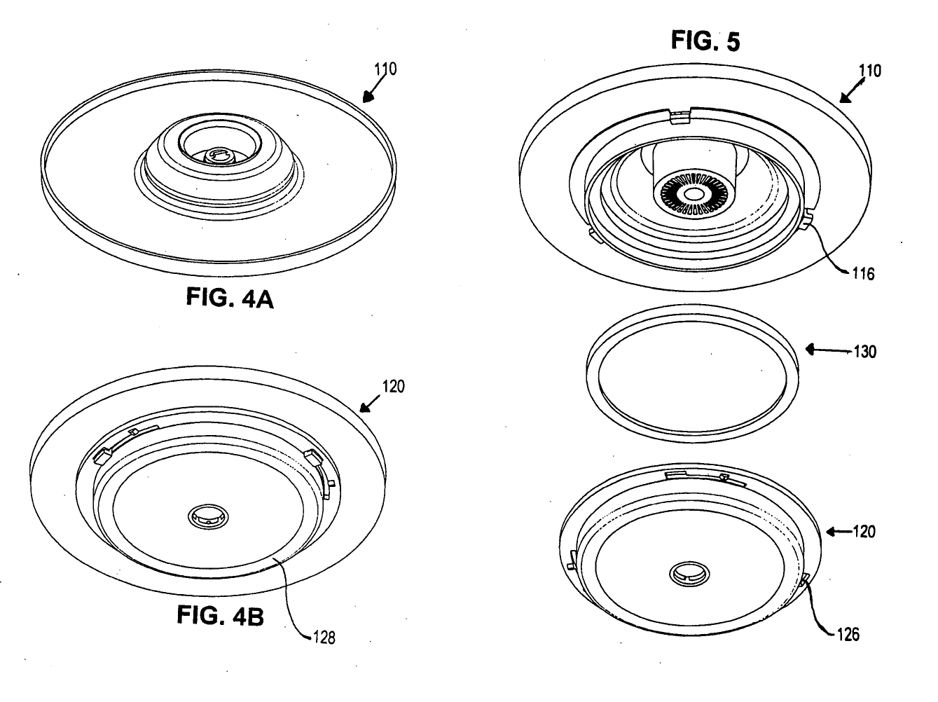

FIG. 4A is a top isometric view of a top portion, or upper housing portion, of a filter housing according to another embodiment of the present invention. FIG. 4B is a bottom isometric view of a bottom portion, or lower housing portion, of a filter housing according to another embodiment of the present invention. FIGS. 2A and 2B illustrated top and bottom filter housing portions wherein the top portion can be twisted off for removal. FIGS. 4A and 4B, on the other hand, illustrate top and bottom filter housing portions wherein the bottom portion can be twisted off for removal. The shape of the “basin” in the lower housing portion provides a suitable natural grip 128 for removal of the lower housing portion 120. However, additional grip elements can be provided to facilitate removal.

FIG. 5 illustrates an exploded view of a filter housing according to another embodiment of the present invention. The embodiment of FIG. 5 is essentially similar to that shown in FIGS. 4A and 4B, but with a bottom perspective view of the upper housing portion 110 showing upper housing locking portions 116 to mate with lower housing locking portions 126. As described earlier, the upper housing portion and the lower housing portion can each comprise locking portions co-operating with each other to removably secure the upper housing portion to the lower housing portion. The embodiment shown in FIG. 5 also shows a filter media 130 for securing between the upper and lower housing portions 110 and 120.

Filter Media Characteristics

Embodiments of the present invention provide a filter housing that enables an increase in water flow rate through the water filter when compared with known or conventional filter housings and filter arrangements. Using a flat carbon filter fabric such as in a preferred embodiment of the present invention obviates the need for slowing down the water to increase contact time since these types of filters do not work on the principle of contact time but rather primarily work on the principle of permitting or restricting particles through the filter simply by way of the size of the particles compared to the openings in the filter media. This can also be described as the water passing through the membrane size, or the pore size, which is what catches unwanted particles in a fabric type filter. For example, in one tested application, the KX filter used had a nominal membrane or pore size of 0.5 micrometers. However, the geometry of a filter housing according to an embodiment of the present invention has been shown to increase water flow/pour through rate, even when used with other types of filters.

Another advantage of the use of the flat filters according to embodiments of the present invention is that the filter itself does not extend as much in the lower reservoir as in the case of GAC filter cartridges, thereby providing a larger volume for water to be held in the lower reservoir. The large size, and length, of the GAC filters is primarily due to the fact that a long path should be provided in order to ensure appropriate and sufficient contact time in such applications.

The filter media used in accordance with some preferred embodiments of the present invention primarily takes care of reducing the chlorine and heavy metal content from the water being poured through the filter. It is possible that other enhancements in water quality can be achieved with use of such a filter. Of course, the chemical makeup of the flat filter material can be modified, such as by adding ion exchange resins, in order to vary the performance of the filter in relation to any number of desirable performance characteristics with respect to particular elements or particles that are sought to be reduced in terms of their presence in water after it has passed through the filter. Elements of interest can include lead, copper, cadmium, etc.

The flat-water filter can be a filter such as the PLEKX™ water filters from KX Industries, which is a flat sheet activated carbon water filtration media. While the PLEKX™ filter generally comprises a cover sheet and a carrier sheet, in between which an extruded medium is placed, a filter medium to be used according with an embodiment of the present invention can be any such type of a flat filter. For example, the extruded medium could be replaced with-granulated carbon between the cover sheet and carrier sheet. However, the use of a carbon sheet filter in general reduces the appearance of stray carbon particles often found when granulated activated carbon filters are used.

In order to determine preferred characteristics for filter media size/properties, which therefore can affect the characteristics of the filter housing, various performance tests were performed. Initial tests were conducted using a bowl without check valves to eliminate obstructions, the results of which are presented herein. A single layer of carbon fabric filter was used. Two litres of water was poured into the bowl and the time for one litre to pass through the filter was timed. Other tests, which may provide a closer indication of real-life performance, are being conducted.

TABLE 1

| | | | | Ref. Brita (top |
|---|---|---|---|---|
| | | | | reservoir kept |
| | | | | filled only holds |
| TEST | 2.25″ Diameter | 3″ Diameter | 3.62″ Diameter | approx. 1 L) |
| 1 | 4 min 50 sec | 1 min 6 sec | 2 min | 4 min 25 sec |
| 2 | 3 min 40 sec | 48 sec | 1 min 20 sec | 5 min 30 sec |
| 3 | 3 min 17 sec | 50 sec | 1 min 17 sec | 5 min 56 sec |
| 4 | 4 min 12 sec | 1 min 13 sec | 1 min 10 sec | 5 min 35 sec |
| 5 | 3 min 8 sec | 1 min 10 sec | 1 min 10 sec | 6 min |
| 6 | 2 min 2 sec | 1 min 2 sec | 1 min 8 sec | |
| 7 | | 58 sec | 1 min 8 sec | |
| 8 | | 56 sec | 1 min sec | |
| AVG | 3 min 40 sec | 58 sec | 1 min 18 sec | 5 min 29 sec |

The results in Table 1 indicate that a filter diameter of 3 inches provided the fastest/best flow in terms of the filter diameters that were tested. It appears from the testing that the smaller size filter may have insufficient flow due to smaller surface area. The larger filter diameter may have sufficient surface area, but likely has an associated higher restriction due to surface tension of the water. Out of those diameters tested, the 3 inch diameter filter has the best balance between surface area and surface tension given this particular test set up. Further test results may indicate an increased efficiency at a different diameter for a different set up, e.g. larger inlet port, etc. Therefore, a filter housing according to an embodiment of the present invention can preferably be shaped and constructed to hold a flat carbon fabric filter in the range of about 2 inches to about 4 inches, preferably between about 2.25 inches and about 3.62 inches and most preferably about 3 inches in diameter.

The earlier discussion of water weight can provide some explanation as to why a larger diameter, i.e. larger than 3 cm, of flat filter did not perform better. It is possibly due to the fact that the large water weight is being spread out over a larger surface area, thereby reducing the water flow rate. With the smaller diameter, such as the 2.25″ diameter, it is possible that the smaller surface area does not provide enough pores or membranes through which the water can flow rapidly.

When discussing different diameters of filter in accordance embodiments of the present invention, this refers to the diameter of the filter media itself. However, if a smaller diameter is used, the dimensions of the filter housing itself can be modified in order to remove the outer wall of the lower housing portion towards the center of the filter housing in proportion to the reduction in filter diameter.

Variations in pour through time can be attributed to the fact that water flowing through a filter often follows a path of least resistance, which may be a path previously taken by water travelling through a particular part of the filter. Such tunnelling occurs in different manners and to different extents.

Although the filter housing and filter media are shown in generally circular shapes according to embodiments of the present invention, other shapes can be used while still providing advantages, such as a square shape, triangular shape, diamond shape, etc. These variations in filter housing and filter media should correspond to a similar variation in the shape of the upper reservoir and/or lower reservoir of the drinking water pitcher, in order to ensure proper fit.

Filter Housing in Drinking Water Pitcher

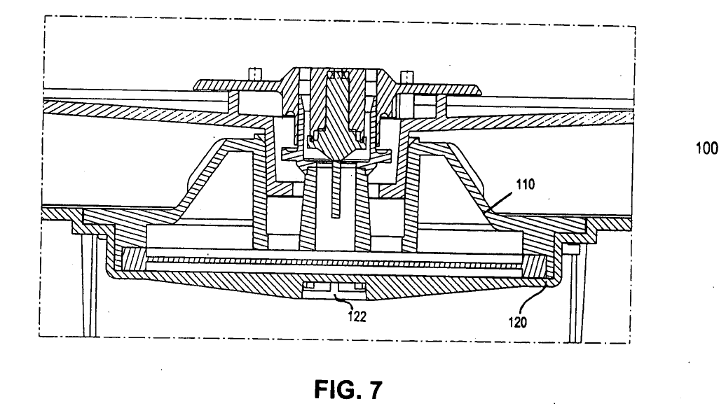

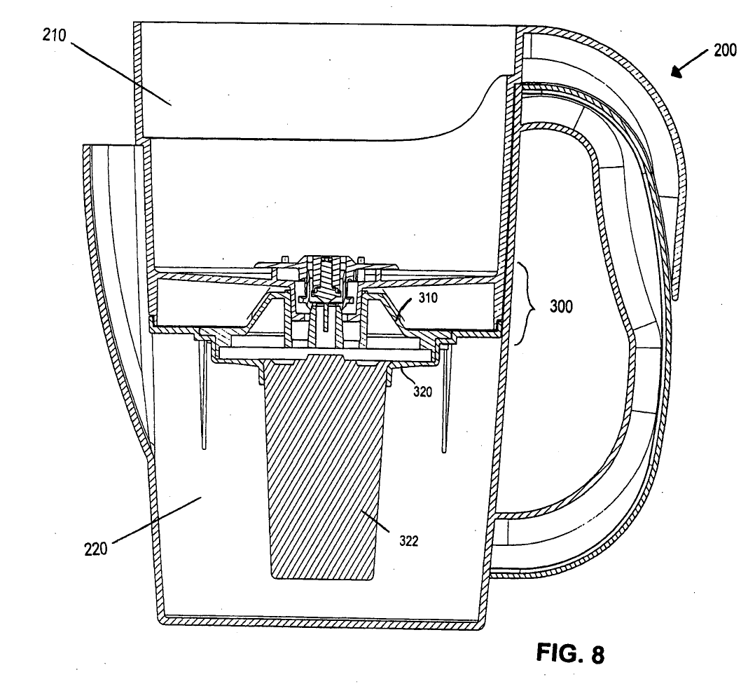

FIG. 6 is a section view of a drinking water pitcher 200 including a filter housing 100, preferably including a filter media, according to an embodiment of the present invention. FIG. 7 is a close up section view of the filter housing and surrounding elements of FIG. 6, providing a clearer view of the interaction of an upper reservoir 210 and lower reservoir 220 with elements of the filter housing 100. With respect to the filter housing itself, the lower housing portion includes an exit port 122. The exit port is preferably provided at or around the center of a preferably disk shaped area of the lower housing portion. This preferably annular or round opening can provide one substantially continuous stream of water flowing out from the filter. This water exiting the lower housing acts to pull the rest of the water out of the housing and therefore contributes to enhancement of the flow through rate.

The filter housing 100 is preferably removably inserted between a removable upper reservoir 210 and a lower reservoir 220 of a drinking water pitcher 200. An example of such a drinking water pitcher is described in co-pending U.S. Provisional Patent Application Ser. No. 60/645,072, filed Jan. 21, 2005 and entitled “Drinking Water Pitcher Having Removable Upper Reservoir”, which is incorporated herein by reference. Means are preferably provided to removably secure the filter housing to the lower reservoir. Alternatively, suitable means are preferably provided to removably secure the filter housing to the upper reservoir.

In an alternate embodiment, the filter housing could be integrated within a removable upper reservoir in a drinking water pitcher. In such a case, the lower reservoir includes some sort of means to open the valve or enable water flow from the upper reservoir through the filter. This means could possibly extend through the filter and into the upper reservoir in which the valve or other water restriction means could be opened to provide for a water flow from the upper reservoir through the filter into the lower reservoir.

In some embodiments of the present invention, such as shown in FIG. 6 and in FIG. 4, where the upper filter housing is designed for mating with the upper reservoir, the upper reservoir 210 includes a double check valve and its associated geometry. However, the geometry of the upper filter housing can be modified in order to accommodate any type of removable upper reservoir, the base of which can include any number of types of valves or openings by which water from the upper reservoir can be selectively fed into the filter, such as a water restriction means.

The filter housing 100 preferably engages the lower reservoir of a drinking water pitcher with some sort of locking or attaching mechanism. The filter housing can alternatively engage with the upper reservoir of a drinking water pitcher. In terms of the lower reservoir, this can be as simple as having small projections extending toward the inside of the reservoir, these projections having a top portion on which the filter housing, which is preferably disk shaped, can sit in order to prevent the disk from falling further into the lower reservoir. A simple tapering of the lower reservoir itself can also accomplish a similar goal.

Alternatively, the filter housing can be integral with the drinking water pitcher. In order to retain the feature of being able to replace the filter media within the filter housing, modifications can be made. For example, the top half of the filter housing can be integrated in the removable upper reservoir of the drinking water pitcher, with the lower portion of the filter housing being removable. Preferably, this upper reservoir would include a water restriction means to prevent water from passing out of the exit port of the filter housing. Alternatively, the lower portion of the filter housing can be integrated in the lower reservoir of a drinking water pitcher, with the upper portion of the filter housing being removable. 10076] Moreover, while the inner geometry of the filter housing is preferably kept as shown in the drawings, the outer geometry of the filter housing can be modified in order to accommodate a sleeker design or a more aesthetically pleasing shape. The engagement of the upper filter housing with the lower filter housing can be achieved by a taper lock, a screw-in mechanism, or any other means of engaging the top filter housing with the bottom filter housing. Similar locking or engaging mechanisms can be used for securing the filter with the lower reservoir.

In addition to the three features described earlier in relation to increased water flow through rate, a possible fourth contribution exists, namely that the water pressure of the entire upper reservoir is being concentrated at the head of the pitcher through a smaller surface area. The manner in which the upper reservoir 210 mates with the filter housing 100 contributes to providing this restricted or reduced surface area and therefore an increased head pressure. Because there is a lot of water weight at the top being concentrated through a very small opening, this is in contrast to conventional approaches, where the vessel itself can take up the weight of the water being held, and thereby possibly slowing down the water flow.

In previous approaches it is primarily the weight of the volume of water directly above the opening to the filter that provides head pressure, while the weight of the water in other surrounding areas is supported by the pitcher or upper reservoir itself. In embodiments of the present invention, the filter is preferably provided outside of the upper reservoir, and preferably in the lower chamber or mating with the lower reservoir. The pressure from the restricted surface area at the base of the upper reservoir is applied, resulting in pushing the water out once the valve or other similar means in the upper reservoir is opened. Therefore, the head pressure of the entire volume of water can contribute rather than just the head pressure of the volume of water locally above the opening as in known approaches. This feature is partly due to the fact that the filter is separated from the upper reservoir.

In other words, in an aspect, the present invention provides a drinking water pitcher, including an upper reservoir, a lower reservoir, and a filter provided between the upper reservoir and the lower reservoir such that head pressure from the upper reservoir is applied within the filter. The filter includes an upper housing portion, a lower housing portion, and a removable filter media housed in between the upper and lower housing portions. The upper housing portion includes a necked down inlet port in an upper surface thereof to increase water flow through rate, and an upper housing chamber to trap air to provide substantially uniform pressure across the filter media. The lower housing portion defines an exit port in a lower surface thereof. The volume of the lower housing portion increases in proximity to the exit port to create a substantially consistent surface tension across the filter media.

The filter housing can be removably attached to the lower reservoir, or can be seated within the lower reservoir. The filter housing can be removably attached to the upper reservoir, or integral with the upper reservoir. The upper housing portion and a bottom surface of the upper reservoir can be complementary in shape.

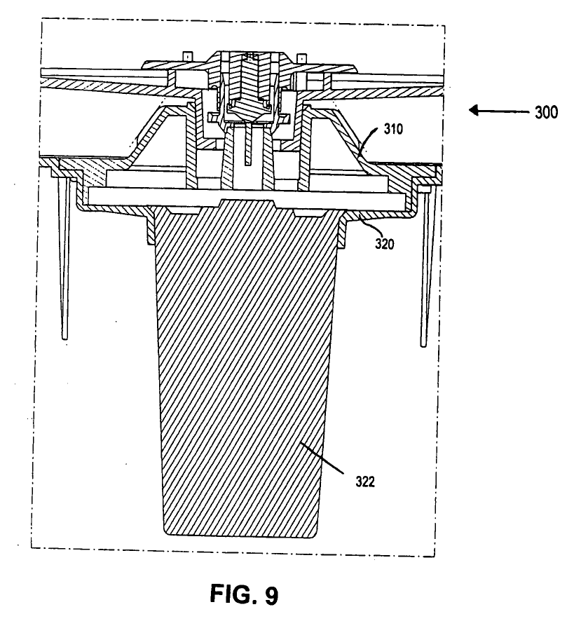

FIG. 8 illustrates a side sectional view of a drinking water pitcher including a filter housing 300 according to a further embodiment of the present invention. In the embodiment of FIG. 8, the filter housing accommodates a known GAC filter rather than a flat carbon fibre filter. FIG. 9 is a close up section view of the filter housing and surrounding elements of FIG. 8.

The upper housing 310 in FIG. 9 is essentially similar to that described in relation to previous embodiments. The lower housing 320 can be modified in order to accommodate the granulated activated carbon filter 322. In one embodiment, the lower housing does not include the tapered bottom portion of the lower filter housing, in order to provide for interoperability with existing GAC filter cartridges. Because the lower housing 320 actually includes a GAC filter 322, the embodiment including filter housing 300 can be described simply as a filter, since it includes the filter media integral with the lower housing portion of the filter housing.

In another embodiment (not illustrated), the lower housing 320 includes a tapered bottom portion, as described in relation to previous embodiments. In such a case, the GAC filter cartridge can be modified such that the carbon particles are laid out over a large enough diameter so that enough water can hang from the underside of the carbon particles to create a significant suction effect. A screen or netting, or other means, can be used to hold the carbon, and the suction effect can be created on the underside of the screen or netting.

Therefore, in a further aspect, the present invention provides a filter for a drinking water pitcher, including an upper housing portion. The upper housing portion includes a necked down inlet port in an upper surface thereof to increase water flow through rate. The upper housing portion also includes an upper housing chamber to trap air to provide substantially uniform pressure across a lower opening of the upper housing portion. The filter further includes a lower housing portion including a granulated activated carbon (GAC) filter. The lower housing portion can define an exit port in a lower surface thereof, and a volume of the lower housing portion can increase in proximity to the exit port to prevent bottleneck.

In addition to use with pitchers as shown in FIGS. 6 and 8, a filter housing according to an embodiment of the present invention could also be used in under the counter water filtration units in order to increase the water flow through rate.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A filter housing for a drinking water pitcher, comprising:
an upper housing portion including:
a necked down inlet port in an upper surface thereof to increase water flow through rate;
an upper housing chamber to trap air to provide substantially uniform pressure across a lower opening of the upper housing portion; and
a lower housing portion defining an exit port in a lower surface thereof, a volume of the lower housing portion increasing in proximity to the exit port to prevent bottleneck.

2. The filter housing of claim 1, wherein the volume of the lower housing portion increases progressively in proximity to the exit port.

3. The filter housing of claim 1, wherein the volume of the lower housing portion has a greater depth at the middle of the lower surface than at the outer portions of the lower surface.

4. The filter housing of claim 1, wherein the lower surface of the lower housing portion extends to the exit port at an angle.

5. The filter housing of claim 4, wherein the angle of the lower surface is about 6.2 degrees from the horizontal.

6. The filter housing of claim 1, wherein the lower housing portion defines a single exit port to provide a single stream of water flowing out from the filter housing.

7. The filter housing of claim 1, wherein the exit port is provided at about the center of the lower housing portion.

8. The filter housing of claim 1, wherein the lower housing portion has a greater depth at the outer portions of the lower surface than at the middle of the lower surface.

9. The filter housing of claim 1, wherein the exit port comprises an exit ring adjacent the outer perimeter of the lower surface.

10. The filter housing of claim 1, wherein the lower surface of the lower housing portion comprises a disk shaped area.

11. The filter housing of claim 1, wherein the lower surface of the lower housing portion comprises ribs to direct water flow towards the exit port.

12. The filter housing of claim 1, wherein the necked down inlet port has a smaller cross-sectional area at the bottom thereof than at the top thereof.

13. The filter housing of claim 1, wherein the upper housing portion and the lower housing portion each comprise locking portions co-operating with each other to removably secure the upper housing portion to the lower housing portion.

14. The filter housing of claim 1, wherein the upper housing portion comprises a gripping means.

15. The filter housing of claim 1, wherein the lower housing portion comprises a gripping means.

16. The filter housing of claim 1, wherein the upper housing portion and the lower housing portion are shaped and constructed to hold a flat carbon fabric filter in the range of about 2 inches to about 4 inches in diameter.

17. The filter housing of claim 1, wherein the upper housing portion and the lower housing portion are shaped and constructed to hold a flat carbon fabric filter in the range of about 2.25 inches and about 3.62 inches in diameter.

18. The filter housing of claim 1, wherein the upper housing portion and the lower housing portion are shaped and constructed to hold a flat carbon fabric filter of about 3 inches in diameter.

19. The filter housing of claim 1, further comprising a filter media holder for securing a filter media in between the upper and lower housing portions.

20. The filter housing of claim 1, further comprising a filter media housed in between the upper and lower housing portions.

21. The filter housing of claim 20, wherein the filter media is a flat carbon fabric filter.

22. A filter for a drinking water pitcher, comprising:
an upper housing portion;
a lower housing portion; and
a filter media housed in between the upper and lower housing portions,
the upper housing portion including
a necked down inlet port in an upper surface thereof to increase water flow through rate; and
an upper housing chamber to trap air to provide substantially uniform pressure across the filter media;
the lower housing portion defining an exit port in a lower surface thereof, a volume of the lower housing portion increasing in proximity to the exit port to create a substantially consistent surface tension across the filter media.

23. The filter of claim 22, further comprising a filter media holder for securing the filter media in between the upper and lower housing portions.

24. The filter of claim 22, wherein the filter media is a flat carbon fabric filter.

25. A filter for a drinking water pitcher, comprising:
an upper housing portion including
a necked down inlet port in an upper surface thereof to increase water flow through rate;
an upper housing chamber to trap air to provide substantially uniform pressure across a lower opening of the upper housing portion; and
a lower housing portion including a granulated activated carbon (GAC) filter.

26. The filter of claim 25, wherein the lower housing portion defines an exit port in a lower surface thereof, and a volume of the lower housing portion increases in proximity to the exit port to prevent bottleneck.

27. A drinking water pitcher, comprising:
an upper reservoir;
a lower reservoir; and
a filter provided between the upper reservoir and the lower reservoir such that head pressure from the upper reservoir is applied within the filter, the filter including
an upper housing portion;
a lower housing portion; and
a removable filter media housed in between the upper and lower housing portions,
the upper housing portion including
a necked down inlet port in an upper surface thereof to increase water flow through rate; and
an upper housing chamber to trap air to provide substantially uniform pressure across the filter media;
the lower housing portion defining an exit port in a lower surface thereof, a volume of the lower housing portion increasing in proximity to the exit port to create a substantially consistent surface tension across the filter media.

28. The drinking water pitcher of claim 27, wherein the filter housing is removably attached to the lower reservoir.

29. The drinking water pitcher of claim 27, wherein the filter housing is seated within the lower reservoir.

30. The drinking water pitcher of claim 27, wherein the filter housing is removably attached to the upper reservoir.

31. The drinking water pitcher of claim 27, wherein the upper housing portion and a bottom surface of the upper reservoir are complementary in shape.
